(19) United States
(12) Patent Application Publication
(10) Pub. No.: US 2011/0264851 A1
(43) Pub. Date: Oct. 27, 2011

(54) MEMORY SYSTEM AND DATA TRANSMITTING METHOD THEREOF

(76) Inventors: TAE-KEUN JEON, Seoul (KR); JONGKEUN AHN, Yongin-si (KR)

(21) Appl. No.: 13/176,389

(22) Filed: Jul. 5, 2011

Related U.S. Application Data
(63) Continuation-in-part of application No. 11/694,301, filed on Mar. 30, 2007.

(30) Foreign Application Priority Data
Dec. 7, 2006 (KR) 10-2006-0123966

(51) Int. Cl. G06F 12/00

(52) U.S. Cl. 711/103; 711/E12.069

(57) ABSTRACT

Disclosed is a data transfer method of a memory system which includes reading data from a first non-volatile memory having at least one first chip connected to a controller through a first channel; and transferring the read data to a second non-volatile memory having at least one second chip connected to the controller through a second channel, wherein each of the first and second channels has at least one line for activating a corresponding chip, wherein the first and second channels share at least one data line, and wherein data transfer operations in through the first and second channels are performed in response to data strobe signals.

### CROSS-REFERENCE TO RELATED APPLICATIONS

This application is a continuation-in-part of application Ser. No. 11/694,301, filed Mar. 30, 2007.

### BACKGROUND

Exemplary embodiments relate to a memory system, and more particularly, relate to a data transfer method of the memory system including a plurality of memories.

FIG. 1 is a block diagram illustrating a typical memory system. Referring to FIG. 1, a memory system 100 may include a controller 160 and memories 120 and 140. Herein, the memories 120 and 140 may be formed of a NAND flash memory. The memories 120 and 140 may be connected to the controller 160 through a common bus. Chip enable signal (CEb) lines and Ready/Busy signal (RBb) lines of the memories 120 and 140 may be connected to the controller 120 independently from each other.

FIG. 2 is a diagram for describing a method of transferring data between memories in a typical memory system in FIG. 1. A memory system 100 may be configured to transfer data from a source page 124 of the first memory 120 to a destination page 144 of the second memory 140. This will be more fully described below.

Referring to FIG. 2, data of the source page 124 of the first memory 120 may be transferred to a page buffer 126 (\textcircled{1}). The data stored in the page buffer 126 may be transferred to a buffer 162 of the controller 160 (\textcircled{2}). The data stored in the buffer 162 of the controller 160 may be transferred to a page buffer 146 of the second memory 140 (\textcircled{3}). The data transferred to the page buffer 146 may be transferred to the destination page 144 of the second memory 140 (\textcircled{4}).

FIG. 3 is a timing diagram illustrating a data transfer manner described in FIG. 2. Referring to FIG. 3, data transfer of a typical memory system 100 may be made by reading page data from the first memory 120 and then writing the read page data into the second memory 140. For this data transfer, the controller 160 may select one of the first and second memories 120 and 140 to transfer a read or write command to the selected memory. The selected memory may generate a ready/busy signal RBb0 or RBb1 to prevent the controller 160 from accessing the selected memory which is conducting a read or write operation.

A page size of the NAND flash memory may be increasing. In case of the typical memory system 100, a write operation may be performed after execution of a read operation in order to transfer data between NAND flash memories. Accordingly, an increase in a page size may cause an increase in a data transfer time.

### SUMMARY

One aspect of embodiments of the inventive concept is directed to provide a data transfer method of a memory system which comprises reading data from a first non-volatile memory having at least one first chip connected to a controller through a first channel; and transferring the read data to a second non-volatile memory having at least one second chip connected to the controller through a second channel, wherein each of the first and second channels include at least one line for activating a corresponding chip, wherein the first and second channels share at least one data line, and wherein data transfer operations in the first and second channels are performed in response to data strobe signals.

In this embodiment, the reading data from a first non-volatile memory comprises reading data in response to a read enable signal; and outputting the read data to the first channel in response to a first data strobe signal of the data strobe signals.

In this embodiment, the outputting the read data to the first channel comprises outputting the read data in response to toggling of the first data strobe signal.

In this embodiment, the transferring the read data to the second non-volatile memory comprises receiving the read data in response to a second data strobe signal of the data strobe signals by the second non-volatile memory.

In this embodiment, the controller is configured to generate the first and second data strobe signals.

In this embodiment, the first and second data strobe signals are single-ended signals.

In this embodiment, the first and second data strobe signals are differential signals.

In this embodiment, the controller is configured to generate the second data strobe signal by delaying the first data strobe signal by a predetermined time.

In this embodiment, the controller is configured to generate the second data strobe signal such that an edge of the second data strobe signal is located at a center of the output data.

In this embodiment, the data transfer method further comprises correcting an error of the read data.

In this embodiment, the read data is output to the first channel in response to a first data strobe signal of the data strobe signals, the error-corrected data is provided to the second channel in response to a second data strobe signal of the data strobe signals, and the second data strobe signal is generated by delaying the first data strobe signal by a time taken to correct an error of the read data.

In this embodiment, the first non-volatile memory is configured to correct an error of the read data.

In this embodiment, the controller is configured to correct an error of the read data.

In this embodiment, the reading data from the first non-volatile memory comprises reading data in synchronization with a clock; and outputting the read data to the first channel in response to a first data strobe signal of the data strobe signals.

Another aspect of embodiments of the inventive concept is directed to provide a memory system which comprises a first non-volatile memory having at least one first chip; a second non-volatile memory having at least one second chip; and a controller configured to connect to the first non-volatile memory through a first channel and the second non-volatile memory through a second channel and to control the first and second non-volatile memories, wherein the respective first and second channels include at least one line for activating the first and second chips respectively, wherein the first and second channels share at least one data line, and wherein data transfer operations in the first and second channels are performed in response to data strobe signals.

In this embodiment, the controller includes an ECC circuit configured to correct an error of data.

In this embodiment, when data is transferred from the first non-volatile memory to the second non-volatile memory, the controller is configured to receive data read from the first non-volatile memory through the first channel, correct an error of the input data in real time, and transfer the error-corrected data to the second non-volatile memory through the second channel.

In this embodiment, the read data is transferred to the controller through the first channel in response to a first data strobe signal of the data strobe signals and the error-corrected data is transferred through the second channel in response to a second data strobe signal of the data strobe signals.

In this embodiment, the controller includes a data strobe signal generator configured to generate the first and second data strobe signals.

In this embodiment, the at least one line includes at least one line receiving at least one chip enable signal, at least one line receiving at least one data strobe signal, a line receiving a write protection signal, and at least one line outputting at least one ready/busy signal.

In this embodiment, the first and second channels share a line receiving an address latch signal and a line receiving a command latch signal.

Still another aspect of embodiments of the inventive concept is directed to provide a memory system which comprises a first non-volatile memory having at least one first chip; a second non-volatile memory having at least one second chip; and a controller configured to connect to the first non-volatile memory through a first channel and the second non-volatile memory through a second channel and to control the first and second memories, wherein the respective first and second channels include at least one line for activating the first and second chips respectively, wherein the first channel includes at least one first data line for outputting the read data, wherein the second channel includes at least one second data line for inputting the output data, wherein the first and second data lines are separated, and wherein data transfer operations in the first and second channels are performed in response to data strobe signals.

In this embodiment, the first and second memories are configured to receive a shared clock.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram illustrating a typical memory system.

FIG. 2 is a diagram for describing a method of transferring data between memories in a typical memory system in FIG. 1.

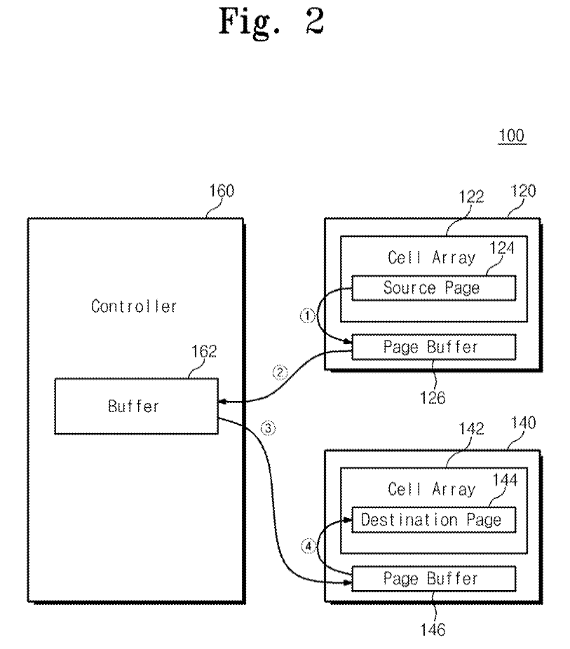

FIG. 3 is a timing diagram illustrating a data transfer manner described in FIG. 2.

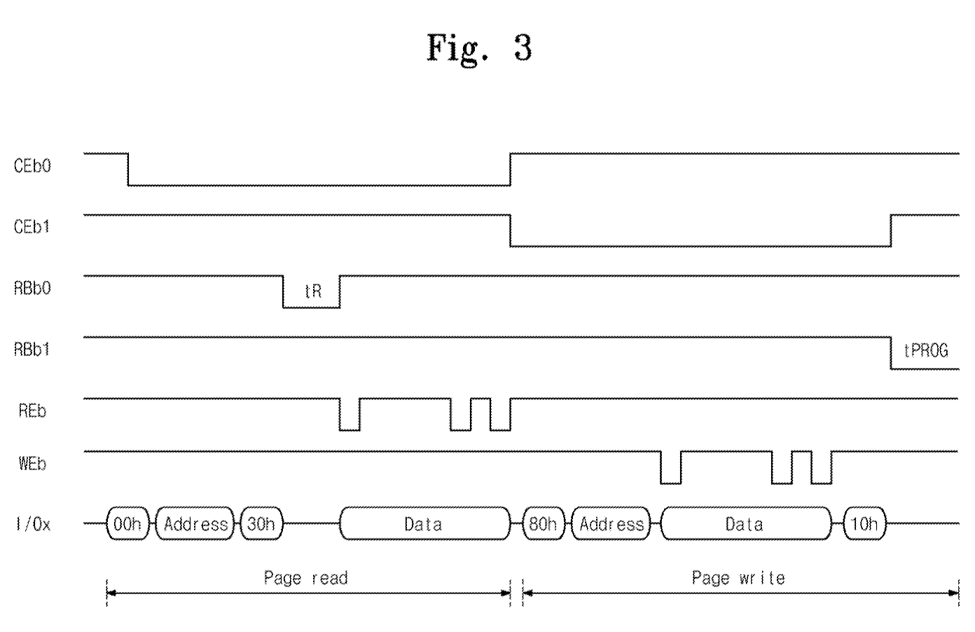

FIG. 4 is a block diagram illustrating a memory system according to an exemplary embodiment of the inventive concept.

FIG. 5 is a block diagram for describing a method of transferring data between the memories in a memory system according to an exemplary embodiment of the inventive concept.

FIG. 6 is a timing diagram for describing a data transfer operation of a memory system according to an exemplary embodiment of the inventive concept.

FIG. 7 is a diagram for describing data transmission times of a memory system 200 according to an exemplary embodiment of the inventive concept and a typical memory system.

FIG. 8 is a block diagram illustrating a memory system according to another exemplary embodiment of the inventive concept.

FIG. 9 is a timing diagram for describing a data transfer method of a memory system in FIG. 8 according to another exemplary embodiment of the inventive concept.

FIG. 10 is a block diagram illustrating a memory system according to another exemplary embodiment of the inventive concept.

FIG. 11 is a timing diagram for describing a data transfer method of a memory system in FIG. 10 according to another exemplary embodiment of the inventive concept.

FIG. 12 is a block diagram illustrating a memory system according to still another r exemplary embodiment of the inventive concept.

FIG. 13 is a timing diagram for describing a data transfer method of a memory system in FIG. 12 according to still another exemplary embodiment of the inventive concept.

FIG. 14 is a block diagram illustrating a memory system according to still another exemplary embodiment of the inventive concept.

FIG. 15 is a timing diagram for describing a data transfer method of a memory system in FIG. 14 according to still another exemplary embodiment of the inventive concept.

FIG. 16 is a flowchart for describing a data transfer method according to an exemplary embodiment of the inventive concept.

FIG. 17 is a block diagram illustrating a memory system according to an exemplary embodiment of the inventive concept.

FIG. 18 is a block diagram of a memory card according to an exemplary embodiment of the inventive concept.

FIG. 19A is a block diagram illustrating a moviNAND device according to an exemplary embodiment of the inventive concept.

FIG. 19B is a block diagram illustrating a moviNAND device according to another exemplary embodiment of the inventive concept.

FIG. 20 is a block diagram illustrating an SSD according to an exemplary embodiment of the inventive concept.

FIG. 21 is a block diagram illustrating a computing system according to an exemplary embodiment of the inventive concept.

FIG. 22 is a block diagram illustrating an electronic device according to an exemplary embodiment of the inventive concept.

FIG. 23 is a block diagram illustrating a server system including an SSD in FIG. 20 according to an exemplary embodiment of the inventive concept.

FIG. 24 is a block diagram illustrating a PPN device according to an exemplary embodiment of the inventive concept.

FIG. 25 is a block diagram illustrating a mobile electronic device according to an exemplary embodiment of the inventive concept.

### DETAILED DESCRIPTION

The inventive concept is described more fully hereinafter with reference to the accompanying drawings, in which embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

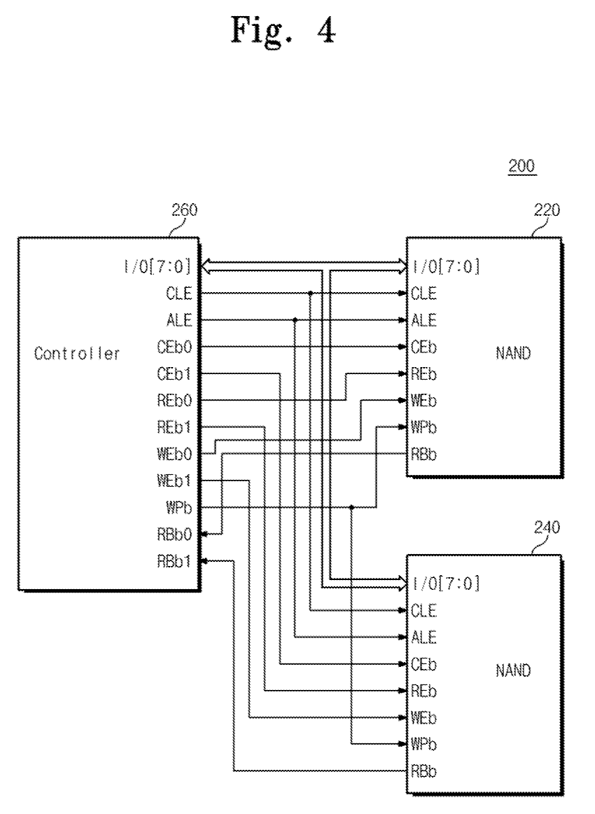

FIG. 4 is a block diagram illustrating a memory system according to an exemplary embodiment of the inventive concept. Referring to FIG. 4, a memory system 200 may include a controller 260 and the first and second memories 220 and 240. The memory system 200 may be configured such that data read from the first memory 220 is directly stored in the second non-volatile memory 240 without passing through the controller 260. This may enable the data transfer efficiency between the first and second memories 220 and 240 to be improved.

In FIG. 4, there is exemplarily illustrated the case that the first and second memories 220 and 240 are implemented using a NAND flash memory. As illustrated in FIG. 4, typically, the NAND flash memory may include pins I/O[7:0] inputting and outputting data I/O, a pin receiving a command latch enable signal CLE, a pin receiving an address latch enable signal ALE, a pin receiving a chip enable signal CEb, a pin receiving a read enable signal REb, a pin receiving a write enable signal WEb, a pin receiving a write protection signal WPb, and a pin outputting a ready/busy signal RBb.

The input/output pins I/O[7:0] may be used to receive a command and an address. Further, the input/output pins I/O[7:0] may be used to receive data at a write operation and to output data at a read operation. The input/output pins I/O[7:0] may be floated when the memory is deselected or when no data is output.

The command latch enable signal CLE may be used to receive a command signal from the controller 260. For instance, when the command latch enable signal CLE is logically high at a rising edge of the write enable signal WEb, the NAND flash memory may identify a signal input through an input/output bus as a command and may store the input signal, that is, the command in a register (not shown).

The address latch enable signal ALE may be used to receive an address from the controller 220. For instance, when the address latch enable signal ALE is logically high, the NAND flash memory may latch an address at a rising edge of the write enable signal WEb.

The chip enable signal CEb may be used to activate the NAND flash memory.

The read enable signal REb may be used to output serial data of the NAND flash memory to the controller 220.

The write enable signal WEb may be used to control a write operation of the NAND flash memory. For example, the NAND flash memory may latch a command, an address, and data at a rising edge of the write enable signal WEb.

The write protection signal WPb may be used to protect the NAND flash memory from being inadvertently read or written at a power variation. For instance, when the write protection signal WPb is logically low, an internal high voltage generator (not shown) of the NAND flash memory may be reset.

The ready/busy signal RBb may be used to report on a status of the NAND flash memory to the controller 220. For instance, while the NAND flash memory is conducting a program, erase, or read operation, the ready/busy signal RBb having a logical low level may be output to the controller 260.

The first and second memories 220 and 240 according to an exemplary embodiment of the inventive concept may be formed of the above-described NAND flash memory. Pins between the controller 260 and the first and second memories 220 and 240 may be interconnected as follows to transfer data read from the first memory 220 directly to the second memory 240 without passing through the controller 260. The CEb pins, the REb pins, the WEb pins, and the RBb pins of the first and second memories 220 and 240 may be separately connected to the controller 260 as illustrated in FIG. 4.

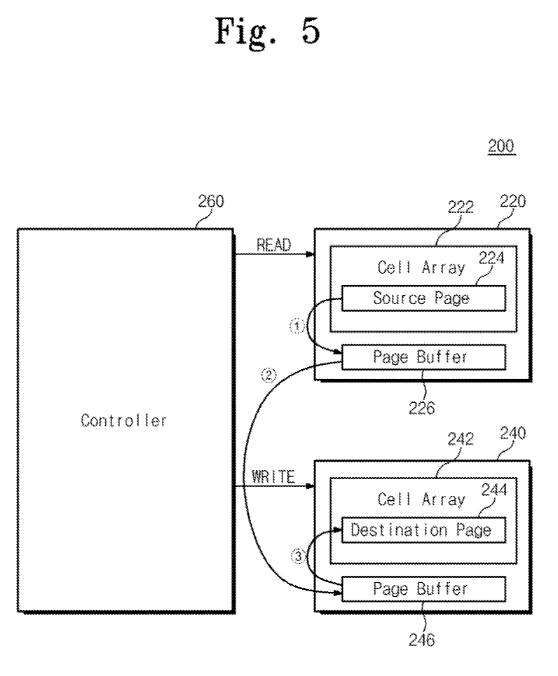

FIG. 5 is a block diagram for describing a method of transferring data between memories in a memory system according to an exemplary embodiment of the inventive concept. Referring to FIG. 5, a memory system 200 may include a controller 260, the first memory 220, and the second memory 240. The first memory 220 may include a memory cell array 222 and a page buffer 226. The memory cell array 222 of the first memory 220 may include a source page 224 storing data to be transferred. The second memory 240 may include a page buffer 246 and a memory cell array 242 having a destination page 244 in which data transferred from the first memory 220 is to be stored. A typical NAND flash memory device may perform a read or a write operation by the page.

The memory system 200 according to an exemplary embodiment of the inventive concept may be configured to transfer data of the source page 224 in the first memory 220 directly to the destination page 244 of the second memory 240 without transferring the read data to the controller 260. Data of the source page 224 of the first memory 220 may be transferred to the destination page 244 of the second memory 240 through the following course.

Referring to FIG. 5, the controller 260 may simultaneously transfer a read command READ to the first memory 220 and a write command WRITE to the second memory 240. The first memory 220 may load data into the page buffer 226 from the source page 224 in response to the read command READ provided from the controller 260. The second memory 240 may be ready to conduct a write operation in response to the write command WRITE provided from the controller 260. With this condition, the data loaded into the page buffer 226 may be sent to the page buffer 246 of the second memory 240, and then the data transferred to the page buffer 246 may be stored in the destination page 244.

With the memory system 200, when data is transferred between the first and second memories 220 and 240, it may not pass through the controller 260. Thus, it is possible to improve a data transfer speed of the memory system 200.

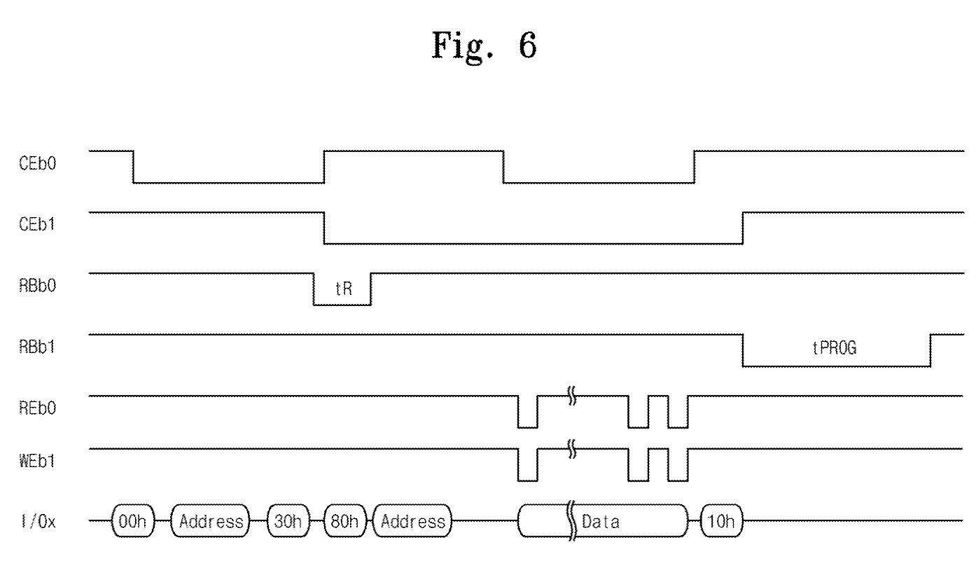

FIG. 6 is a timing diagram for describing a data transfer operation of a memory system according to an exemplary embodiment of the inventive concept. Referring to FIG. 6, a memory system 200 according to an exemplary embodiment of the inventive concept may be configured such that data is directly transferred into the second memory 240 from the first memory 220 without passing through the controller 260, which will be detailed hereinafter.

A controller 260 may transfer the first chip enable signal CEb0 to the first memory 220 so as to conduct a read operation. Then, the first memory 220 may be activated in response to a logical low level of the first chip enable signal CEb0. The first memory 220 thus activated may receive a read command 00h transferred through a data bus in response to an command latch enable signal CLE and may receive an address transferred through the data bus in response to an address latch enable signal ALE. The first memory 220 may load data into the page buffer 226 from the source page 224. At this time, the first memory 220 may generate the first ready/busy signal RBb0 to inhibit an access to itself while the data is being loaded.

During the read operation of the first memory 220, the controller 260 may output the second chip enable signal CEb1 to activate the second memory 240 and may output the first chip enable signal CEb0 to inactivate the first memory 220. The second memory 240 may be activated in response to the second chip enable signal CEb1 of a logically low level. The second memory 240 may receive a write command 80h through the data bus in response to the command latch enable signal CLE and may receive an address through the data bus in response to the address latch enable signal ALE. After transferring the address to the second memory 240, the controller 260 may output the first chip enable signal CEb0 to reactivate the first memory 220 with the second memory 240 being activated.

After then, the controller 260 may send a read enable signal REb0 to the first memory 220 that is being active. The first memory 220 may output data to the data bus from the page buffer 226 in response to the read enable signal REb0. At the same time, the controller 260 may transfer a write enable signal WEb1 to the second memory 240 that is being active. The second memory 240 may load data, which is output from the page buffer 226 of the first memory 220, into the page buffer 246 of the second memory 240 in response to the write enable signal WEb1.

After data transmission from the page buffer 226 of the first memory 220 into the page buffer 246 of the second memory 240 is completed, the controller 260 may send a write command 10h to the second memory 240. When the write command 10h is input, the second memory 240 may start to program the destination page 244 with the data transferred to the page buffer 246. At this time, the second memory 240 may output the second ready/busy signal RBb1 of a logically low level to inhibit an access to the second memory 240. The controller 260 may output the first and second chip enable signals CEb0 and CEb1 to inactivate the first and second memories 220 and 240.

As understood from the above description, the memory system 200 according to an exemplary embodiment of the inventive concept may be configured such that data transmission between the memories 220 and 240 is directly made without passing through the controller 220, which makes a data transmission time shorter.

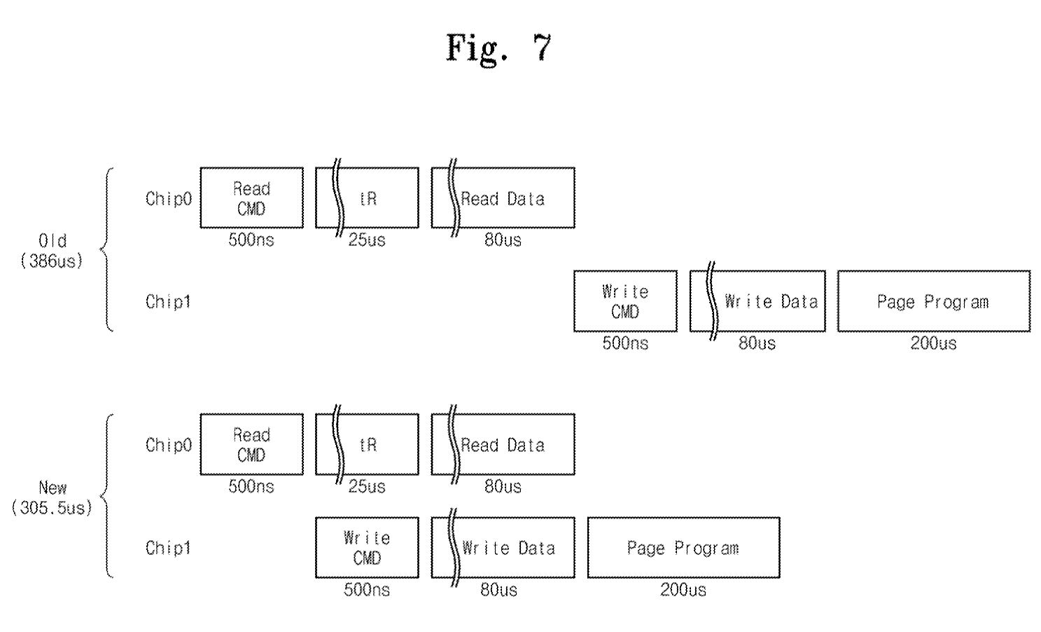

FIG. 7 is a diagram for describing data transmission times of a memory system 200 according to an exemplary embodiment of the inventive concept and a typical memory system.

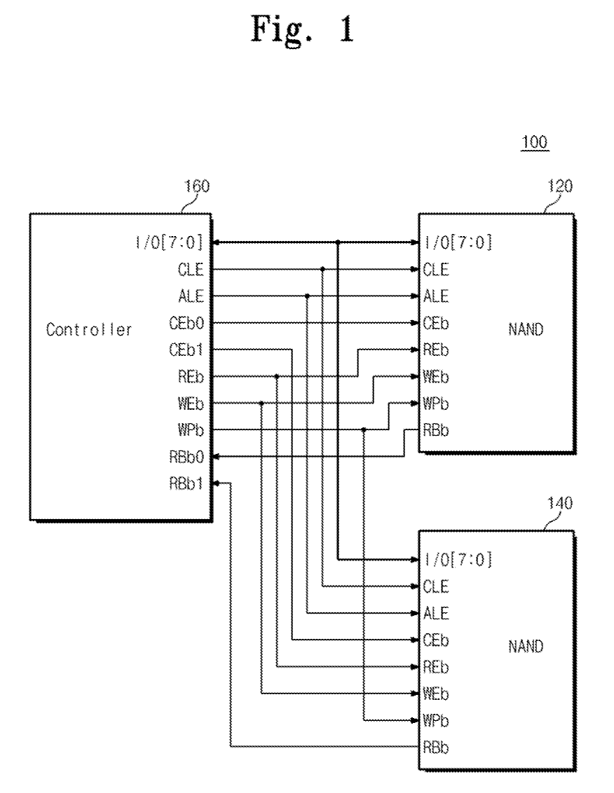

A typical memory system 100 may conduct a write operation after a read operation. Referring to FIGS. 1 and 7, a time taken to transfer data may be about 386 μs corresponding to a sum of a time of 500 ns taken to transfer a read command to the first memory 120 from the controller 160, a time of 25 μs taken to load data into the page buffer 126 from the source page 124, a time of 80 μs taken to transfer the data from the page buffer 126 to the buffer 162 of the controller 160, a time of 500 μs taken to transfer a write command to the second memory 140 from the controller 160, a time of 80 μs taken to transfer the data to the page buffer 146 of the second memory 140 from the buffer 162 of the controller 160, and a time of 200 μs taken to program the data into the destination page 144 from the page buffer 146.

Unlike the typical memory system 100, the memory system 200 according to an exemplary embodiment of the inventive concept may store data directly into the second memory 240 from the first memory 220 without passing through the controller 260. Referring to FIGS. 4 and 7, since times taken to transfer a read command and a write command are overlapped and read data is directly transferred as write data without passing through the controller 260, a total time taken to transfer data may include a time of 105.5 μs taken to perform a read operation and a time of 200 μs taken to perform a program operation. That is, according to an exemplary embodiment of the inventive concept, a total time of 305.5 μs may be taken to transfer data.

As a result, the memory system 200 may be improved up to 21% as compared with a typical memory system 100.

The memory system 200 according to an exemplary embodiment of the inventive concept may be helpful to further reduce a data transmission time so much as a page size becomes larger.

The memory system 200 may be a memory card (e.g., a subscriber identity module (SIM) card).

A data transfer scheme according to an exemplary embodiment of the inventive concept may be applicable to a double data rate (DDR) NAND flash memory-based memory system.

A DDR NAND flash memory is disclosed in a website of http://www.samsung.com/global/business/semiconductor/products/flash/Products_Toggle_DDR_NANDFlash.html, the entirety of which is incorporated by reference herein.

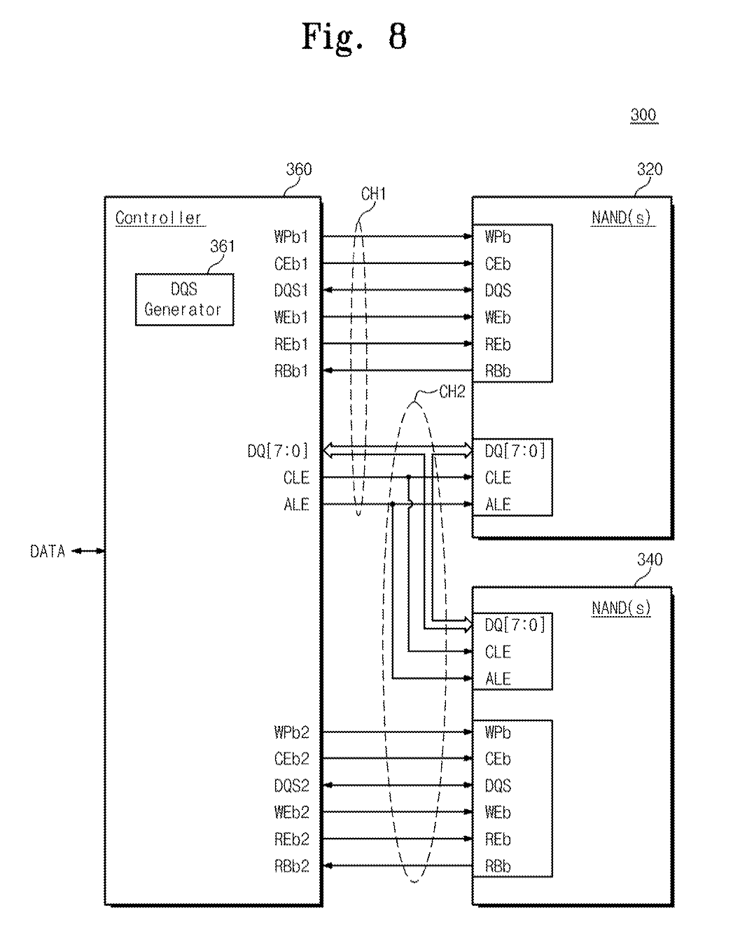

FIG. 8 is a block diagram illustrating a memory system according to another exemplary embodiment of the inventive concept. Referring to FIG. 8, a memory system 300 may include the first memory 320, the second memory 340, and a controller 360. Herein, the first memory 320 may be connected to the controller 360 through the first channel, and the second memory 340 may be connected to the controller 360 through the second channel. Although not shown in FIG. 8, each of the first and second memories 320 and 340 may include at least one chip. Herein, each of the first and second channels CH1 and CH2 may include at least one first line. Each of the first and second channels CH1 and CH2 may share at least one second line. In FIG. 8, two channels CH1 and CH2 are exemplarily illustrated. However, the inventive concept is not limited thereto. The memory system 300 according to an exemplary embodiment of the inventive concept may include at least two channels, each of which is connected to a memory including at least one chip.

The first and second memories 320 and 340 may share data lines DQ[7:0], a line receiving a command latch enable signal CLE, and a line receiving an address latch enable signal ALE. A data transfer operation between the first memory 320 and the second memory 340 or a data transfer operation between the first or second memory 320 or 340 and the controller 360 may be made through at least one shared data line (DQ[7:0] or a data bus) in response to a data strobe signal DQS.

In an exemplary embodiment, the data strobe signal DQS may be generated by the controller 360.

In another embodiment, the data strobe signal DQS may be generated by a device transferring data. For example, when data is output from the first memory 320, the first memory 320 may output the data strobe signal DQS.

Each of the first and second memories 320 and 340 may receive a command from the controller 360 through shared data lines DQ[7:0] in response to the command latch enable signal CLE. This means that the first and second memories 320 and 340 share the data lines DQ[7:0]. In FIG. 8, there is exemplarily illustrated the case that the memory system 300 is configured such that two memories 320 and 340 share the data lines DQ[7:0]. However, the inventive concept is not limited thereto. It is well understood that the memory system 300 according to an exemplary embodiment of the inventive concept includes at least two memories configured to share the data lines DQ[7:0].

Each of the first and second memories 320 and 340 may receive an address from the controller 360 through the shared data lines DQ[7:0] in response to the address latch enable signal ALE.

Each of the first and second memories 320 and 340 may be connected to the controller 360 through a line receiving a write protection signal WPb, at least one line receiving a chip enable signal CEb, a line inputting and outputting a data strobe signal DQS, a line receiving a write enable signal WEb, a line receiving a read enable signal REb, and a line outputting a ready/busy signal RBb.

The controller 360 may be configured to control the first and second memories 320 and 340. The controller 360 may include a data strobe signal generator 361 which is configured to generate the first and second strobe signals DQS1 and DQS2.

In an exemplary embodiment, the data strobe signal generator 361 may generate the second data strobe signal DQS2 by bypassing the first data strobe signal DQS1.

In another embodiment, the data strobe signal generator 361 may generate the second data strobe signal DQS2 by delaying the first data strobe signal DQS1 by a predetermined time.

The memory system 300 according to an exemplary embodiment of the inventive concept may be configured such that data is input and output through the first and second channels CH1 and CH2, sharing at least one second line, in response to the data strobe signal DQS (by toggling the DQS).

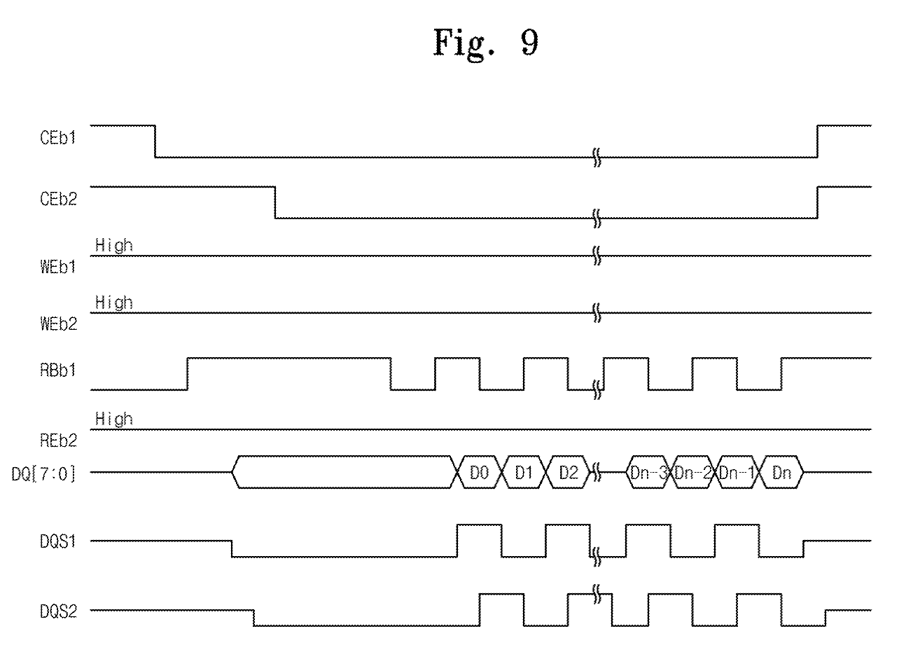

FIG. 9 is a timing diagram for describing a data transfer method of a memory system in FIG. 8 according to another exemplary embodiment of the inventive concept. Below, a data transfer method of a memory system will be more fully described with reference to FIGS. 8 and 9.

The first memory 320 may read data from a source page corresponding to an address to output the read data D0 to Dn to shared data lines DQ[7:0]. In particular, the first memory 320 may be activated in response to the first chip enable signal CEb1 of a low level. The activated first memory 320 may read data D0 to Dn corresponding to an address in response to the first read enable signal REb1 being toggled (or, may transfer sensed data into an output buffer in response to the first read enable signal REb1) and may output the read data D0 to Dn to the shared data lines DQ[7:0] according to toggling of the first data strobe signal DQS1. In an exemplary embodiment, data D0 to Dn may be output at rising and falling edges of the first data strobe signal DQS1. At this time, the first write enable signal WEb1 may have a high level.

The second memory 340 may receive the data D0 to Dn output from the first memory 320 through the shared data lines DQ[7:0] and may store the input data in a destination page. In particular, the second memory 340 may be activated in response to the second chip enable signal CEb2 of a low level. When activated, the second memory 340 may receive the data D0 to Dn from the shared data lines DQ[7:0] in response to the second data strobe signal DQS2. Herein, the second data strobe signal DQS2 may be generated from a controller 360 by delaying the first data strobe signal DQS1 by a predetermined time.

In an exemplary embodiment, a data strobe signal generator 361 of the controller 360 may delay the first data strobe signal DQS1 by a predetermined time. Herein, the predetermined time may be shorter than half a toggling period of the first data strobe signal DQS1.

In an exemplary embodiment, the data strobe signal generator 361 of the controller 360 may generate the second data strobe signal DQS2 such that the second memory 340 receives the data D0 to Dn at a center of the second data strobe signal DQS2.

In an exemplary embodiment, the first and second data strobe signals DQS1 and DQS2 are single-ended signals.

In another exemplary embodiment, the first and second data strobe signals DQS1 and DQS2 are differential signals.

Afterwards, the second memory 340 may store the data D0 to Dn output from the first memory 320 in a destination page. At this time, the second write enable signal WEb2 may have a high level and the second read enable signal REb2 may have a high level.

The memory system 300 according to an exemplary embodiment of the inventive concept may be configured to correct an error in real time when data is transferred between the first and second memories 320 and 340. Herein, an error correcting operation may be performed by the controller 360 or by the first and second memories 320 and 340, respectively. Below, it is assumed that an error correcting operation is made by the controller 360.

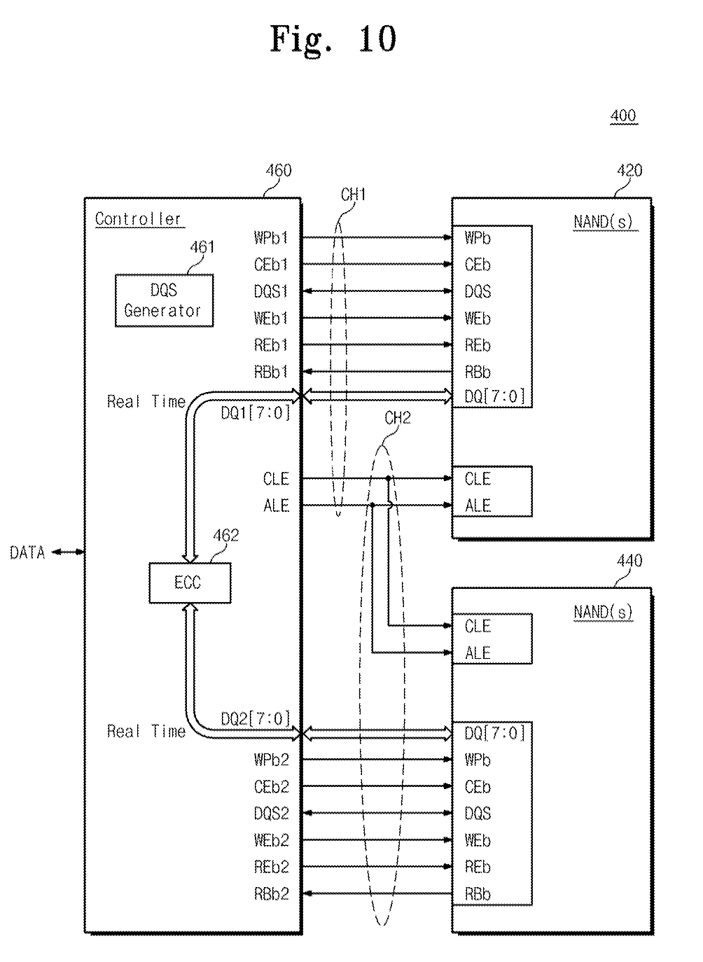

FIG. 10 is a block diagram illustrating a memory system according to another exemplary embodiment of the inventive concept. Referring to FIG. 10, a memory system 400 may include the first memory 420, the second memory 440, and a controller 460. The controller 460 may include an ECC circuit 462 which is configured to correct an error of data.

The first and second memories 420 and 440 may share a line receiving a command latch enable signal CLE and a line receiving an address latch enable signal ALE.

Each of the first and second memories 420 and 440 may receive a command from the controller 460 through corresponding data lines DQ[7:0] in response to the command latch enable signal CLE. The memory system 400 may include two memories 420 and 440. However, the inventive concept is not limited thereto. It is well understood that the memory system 400 according to an exemplary embodiment of the inventive concept includes at least two memories.

Each of the first and second memories 420 and 440 may receive an address from the controller 460 through corresponding data lines DQ[7:0] in response to the address latch enable signal ALE.

Each of the first and second memories 420 and 440 may be connected to the controller 460 through data lines DQ[7:0] inputting and outputting data, a line receiving a write protection signal WPb, at least one line receiving a chip enable signal CEb, a line inputting and outputting a data strobe signal DQS, a line receiving a write enable signal WEb, a line receiving a read enable signal REb, and a line outputting a ready/busy signal RBb.

A data transfer operation between the first memory 420 and the second memory 440 or a data transfer operation between the first or second memory 420 or 440 and the controller 460 may be made through corresponding data lines DQ[7:0] in response to a corresponding data strobe signal DQS.

In particular, a data transfer operation between the first memory 420 and the second memory 440 may be performed in real time through the ECC circuit 462 in the controller 460. For example, data read from the first memory 420 may be sent to the ECC circuit 462 through the first data lines DQ1[7:0] in response to the first data strobe signal DQS1. Data corrected by the ECC circuit 462 may be transferred to the second memory 440 through the second data lines DQ2[7:0] in response to the second data strobe signal DQS2. Herein, the first data strobe signal DQS1 may be generated from the first memory 420, and the second data strobe signal DQS2 may be generated from the controller 460. In an exemplary embodiment, the controller 460 may generate the second data strobe signal DQS2 by delaying the first data strobe signal DQS1 by an ECC delay time when data corrected by the ECC circuit 462 is output.

As illustrated in FIG. 10, the controller 460 may include the ECC circuit 462. However, the ECC circuit can be included in each of the first and second memories 420 and 440.

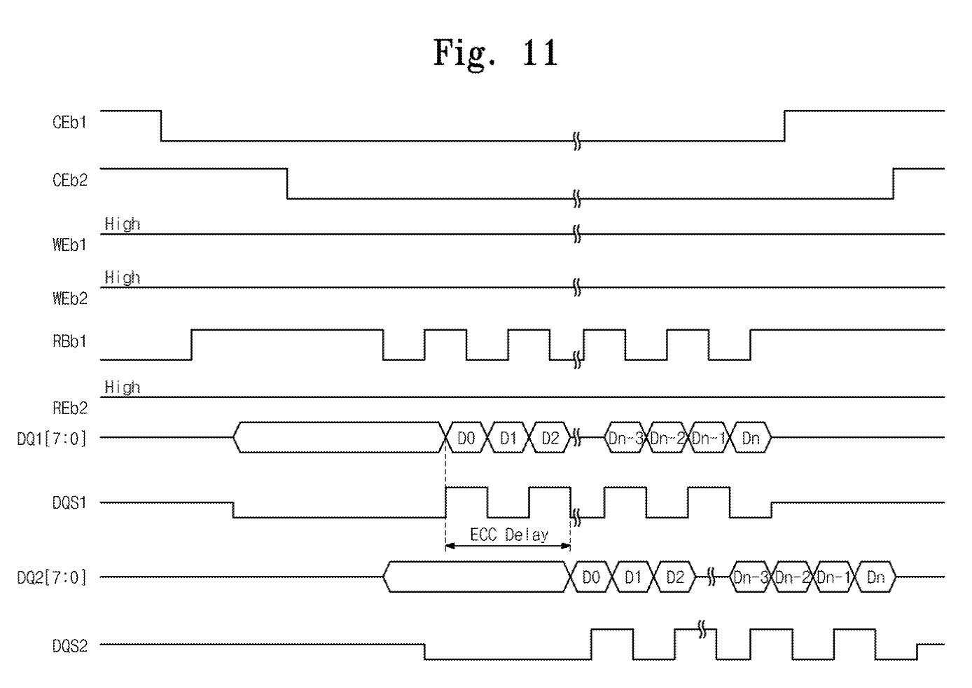

FIG. 11 is a timing diagram for describing a data transfer method of a memory system in FIG. 10 according to another exemplary embodiment of the inventive concept. Below, a data transfer method of a memory system will be more fully described with reference to FIGS. 10 and 11.

The first memory 420 may read data from a source page corresponding to an address to output the read data D0 to Dn to the first data lines DQ1[7:0]. In particular, the first memory 420 may be activated in response to the first chip enable signal CEb1 of a low level. The activated first memory 420 may read data corresponding to an address in response to the first read enable signal REb1 being toggled and may output the read data D0 to Dn to the first data lines DQ1[7:0] according to the first data strobe signal DQS1. In an exemplary embodiment, data may be output at rising and falling edges of the first data strobe signal DQS1, respectively. At this time, the first write enable signal WEb1 may have a high level.

An ECC circuit 462 of a memory controller 460 may detect and correct data input from the first data lines DQ1[7:0] in real time, and may transfer error-corrected data to the second memory 440 through the second data lines DQ2[7:0] in response to the second data strobe signal DQS2.

The second memory 440 may receive the data through the second data lines DQ2[7:0] in response to the second data strobe signal DQS2 and may store the input data in a destination page. In particular, the second memory 440 may be activated in response to the second chip enable signal CEb2 of a low level. When activated, the second memory 440 may receive the data from the second data lines DQ2[7:0] in response to the second data strobe signal DQS2. Afterwards, the second memory 440 may store data output from the first memory 420 in a destination page. At this time, the second write enable signal WEb2 may have a high level, and the second read enable signal REb2 may have a high level.

A data transfer method according to an exemplary embodiment of the inventive concept may be applicable to a memory system including ONFI (Open NAND Flash Interface) NAND flash memory. The ONFI NAND flash memory is disclosed in a website of http://onfi.org/specifications/, the entirety of which is incorporated by reference herein.

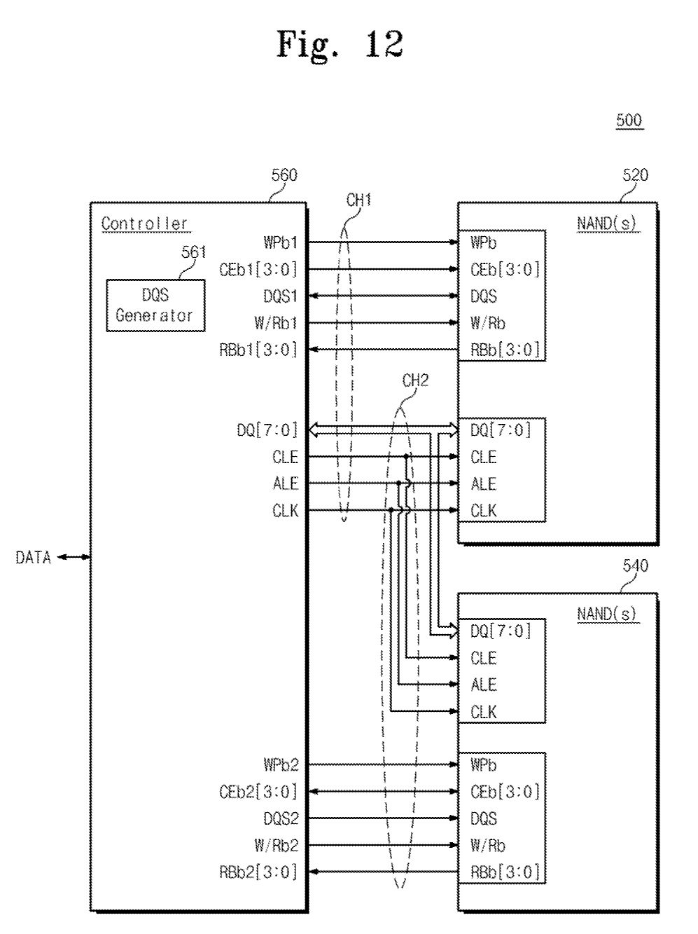

FIG. 12 is a block diagram illustrating a memory system according to still another r exemplary embodiment of the inventive concept. Referring to FIG. 12, a memory system 500 may include the first memory 520, the second memory 540, and a controller 560.

The first and second memories 520 and 540 may share data lines DQ[7:0], a line receiving a clock CLK, a line receiving a command latch enable signal CLE, and a line receiving an address latch enable signal ALE. Herein, a clock-based data transfer operation between the first memory 520 and the second memory 540 and a clock-based data transfer operation between the first or second memory 520 or 540 and the controller 560 may be made through at least one shared data line DQ[7:0] in response to a data strobe signal DQS.

Each of the first and second memories 520 and 540 may be connected to the controller 560 through a line receiving a write protection signal WPb, lines receiving chip enable signals CEb[3:0], a line inputting and outputting a data strobe signal DQS, a line receiving a write/read signal W/Rb, and lines outputting ready/busy signals RBb[3:0].

In FIG. 12, four chip enable signals CEb[3:0] and four ready/busy signals RBb[3:0] may be applied to each of the first and second memories 520 and 540. The reason is because each of the first and second memories 520 and 540 is formed of four chips (not shown). That is, four chips in the first memory 520 may share the first channel CH1, and four chips in the second memory 540 may share the second channel CH2. The memory system 500 according to an exemplary embodiment of the inventive concept may be configured to share data lines DQ[7:0] among lines in the first and second channels CH1 and CH2. The memory system 500 is exemplarily described under the condition that one channel is connected to four chips. However, the inventive concept is not limited thereto. For example, the memory system 500 according to an exemplary embodiment of the inventive concept may include at least two channels each to be connected to at least one chip.

There is exemplarily described the case that four chip enable signals are provided to each of the first and second memories 520 and 540 from the controller 560. However, the inventive concept is not limited thereto. The controller 560 may be configured to output chip enable signals of which the number is determined to transfer an encoding value for designating all chips included in each of the first and second memories 520 and 540. For example, two chip enable signals may be used to transfer 2-bit information for designating four chips.

There is exemplarily described the case that four ready/busy signals RBb[3:0] are provided to each of the first and second memories 520 and 540 from the controller 560. The controller 560 may be configured to output ready/busy signals of which the number is determined to transfer an encoding value for designating all chips included in each of the first and second memories 520 and 540.

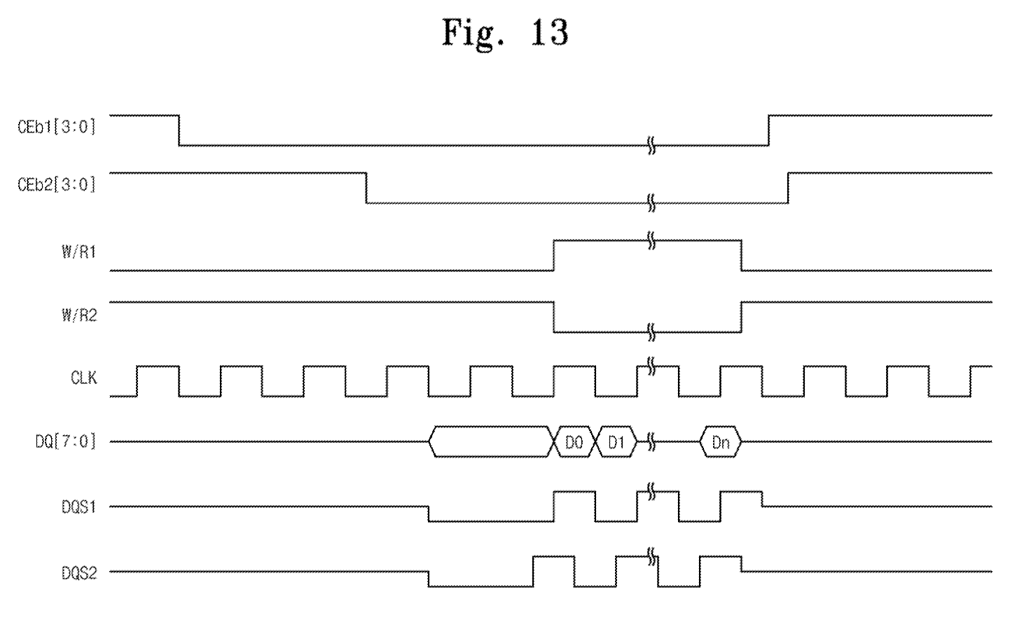

FIG. 13 is a timing diagram for describing a data transfer method of a memory system in FIG. 12 according to still another exemplary embodiment of the inventive concept. Below, a data transfer method of a memory system will be more fully described with reference to FIGS. 12 and 13.

The first memory 520 may read data from a source page corresponding to an address to output the read data to shared data lines DQ[7:0]. In particular, the first memory 520 may be activated in response to the first chip enable signals CEb1[3:0] of a low level. When activated, the first memory 320 may read data corresponding to an address and may output the read data to the shared data lines DQ[7:0] in response to the first data strobe signal DQS1 and in synchronization with a clock CLK. At this time, the first write/read signal W/Rb1 may have a high level.

The second memory 540 may receive the data output from the first memory 520 through the shared data lines DQ[7:0] and may store the input data in a destination page. In particular, the second memory 540 may be activated in response to the second chip enable signals CEb2[3:0] of a low level. When activated, the second memory 340 may receive data from the shared data lines DQ[7:0] in response to the second data strobe signal DQS2 and in synchronization with the clock CLK.

Afterwards, the second memory 540 may store the data input from the first memory 520 in a destination page. At this time, the second write/read signal W/Rb2 may have a low level.

Error correction may be made in real time when data is transferred between memories.

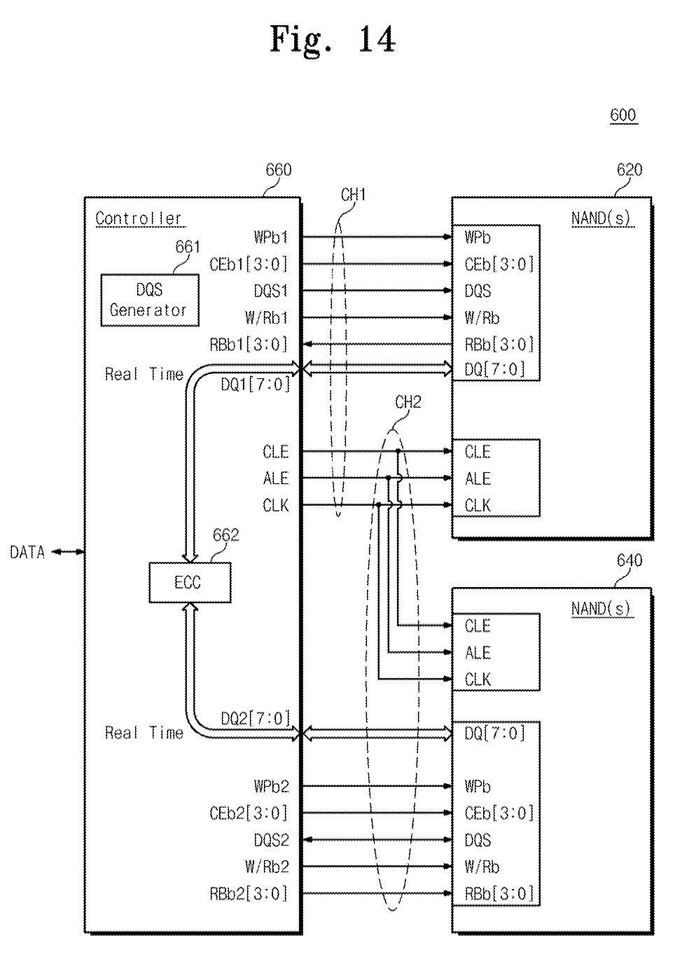

FIG. 14 is a block diagram illustrating a memory system according to still another exemplary embodiment of the inventive concept. Referring to FIG. 14, a memory system 600 may include the first memory 620, the second memory 640, and a controller 660.

The first and second memories 620 and 640 may share a line receiving a clock CLK, a line receiving a command latch enable signal CLE, and a line receiving an address latch enable signal ALE.

Each of the first and second memories 620 and 640 may be connected to the controller 460 through data lines DQ[7:0] inputting and outputting data, a line receiving a write protection signal WPb, lines receiving chip enable signals CEb[3:0], a line inputting and outputting a data strobe signal DQS, a line receiving a write/read signal W/Rb, and lines outputting ready/busy signals RBb[3:0].

A data transfer operation between the first memory 620 and the second memory 640 or a data transfer operation between the first or second memory 620 or 640 and the controller 660 may be made through corresponding data lines DQ[7:0] in response to a corresponding data strobe signal DQS and in synchronization with the clock CLK.

In particular, a data transfer operation between the first memory 620 and the second memory 640 may be performed in real time through an ECC circuit 662 in the controller 660. For example, data read from the first memory 620 may be sent to the ECC circuit 662 through the first data lines DQ1[7:0] in response to the first data strobe signal DQS1. Data corrected by the ECC circuit 662 may be transferred to the second memory 640 through the second data lines DQ2[7:0] in response to the second data strobe signal DQS2.

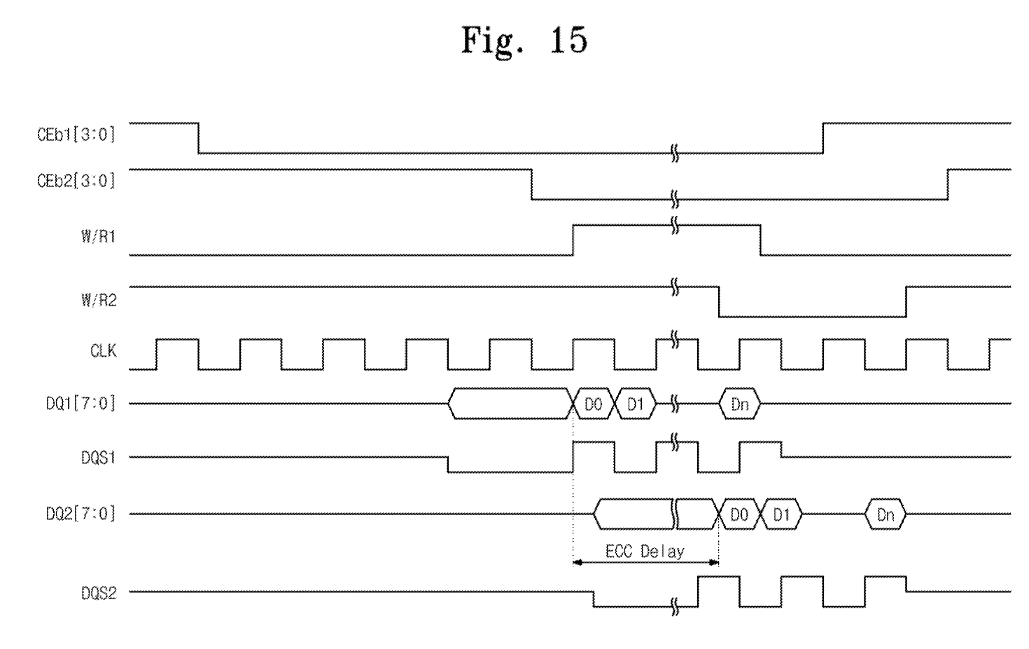

FIG. 15 is a timing diagram for describing a data transfer method of a memory system in FIG. 14 according to still another exemplary embodiment of the inventive concept. Below, a data transfer method of a memory system will be more fully described with reference to FIGS. 14 and 15.

The first memory 620 may read data from a source page corresponding to an address to output the read data to the first data lines DQ1[7:0]. In particular, the first memory 620 may be activated in response to the first chip enable signals CEb1[3:0] of a low level. When activated, the first memory 620 may read data corresponding to an address and may output the read data to the first data lines DQ1[7:0] in response to the first data strobe signal DQS1 and in synchronization with a clock CLK. At this time, the first write/read signal W/R1 may have a high level.

The second memory 640 may receive the data output from the first memory 620 through the second data lines DQ2[7:0] and may store the input data in a destination page. In particular, the second memory 640 may be activated in response to the second chip enable signals CEb2[3:0] of a low level. When activated, the second memory 640 may receive data from the second data lines DQ2[7:0] in response to the second data strobe signal DQS2 and in synchronization with the clock CLK.

Herein the second data strobe signal DQS2 may be delayed by an ECC delay time as compared with the first data strobe signal DQS1.

Afterwards, the second memory 640 may store the data input from the first memory 620 in a destination page. At this time, the second write/read signal W/Rb2 may have a low level.

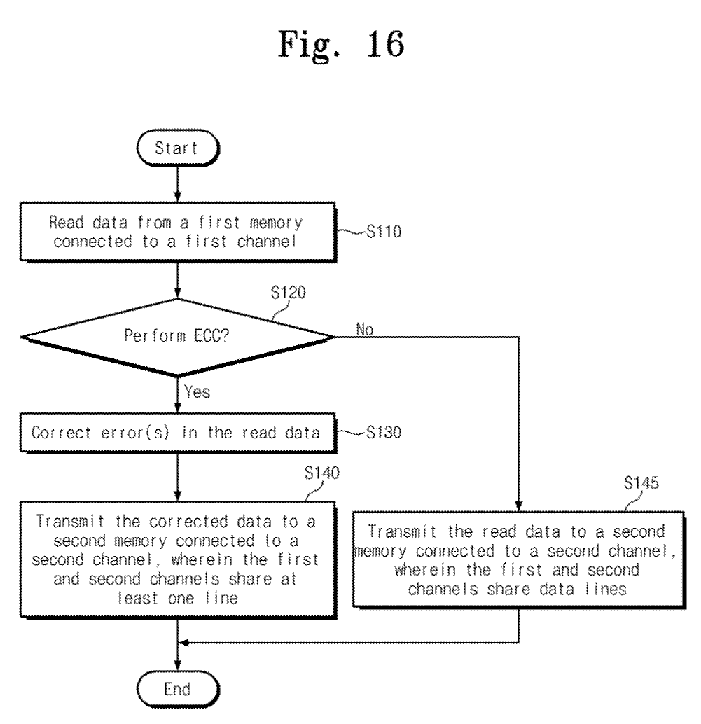

FIG. 16 is a flowchart for describing a data transfer method according to an exemplary embodiment of the inventive concept. Below, a data transfer method according to an exemplary embodiment of the inventive concept will be more fully described with reference to accompanying drawings.

In operation S110, the first memory (e.g., 520 in FIG. 12) connected to the first channel (e.g., CH1 in FIG. 12) may read data from a page corresponding to an address input according to a command of a controller (e.g., 560 in FIG. 12).

In operation S120, the controller may determine whether or not to correct an error of the read data.

In the event that the controller corrects an error of the read data, in operation S130, the read data may be sent to the controller through the first channel and the controller may correct an error of the transferred data using ECC in real time. In operation S140, the corrected data may be transferred to the second memory (e.g., 540 in FIG. 12) connected to the second channel (e.g., CH2 in FIG. 12). Herein, the second channel may be configured to share at least one line with the first channel.

In the event that the controller does not correct an error of the read data, in operation S145, the read data may be transferred to the second memory (e.g., 540 in FIG. 12) connected to the second channel (e.g., CH2 in FIG. 12) without passing through the controller. Herein, the second channel and the second channel may share data lines (e.g., DQ[7:0] in FIG. 12).

In the data transfer method according to an exemplary embodiment of the inventive concept, data may be directly transferred from the first memory to the second memory when no error correction is made. When error correction is required, data transferred from the first memory may be corrected in real time, and the error-corrected data may be transferred to the second memory. Accordingly, it is possible to improve a data transfer speed.

In FIG. 16, a data transfer method is described using memory systems 500 and 600 in FIGS. 12 and 14. However, the inventive concept is not limited thereto. The data transfer method may be applicable to memory systems 200, 300, and 400 in FIGS. 4, 8, and 10.

It was assumed that a memory according to an exemplary embodiment of the inventive concept is a NAND flash memory. However, the inventive concept is not limited thereto. The memory according to an exemplary embodiment of the inventive concept may include a vertical NAND flash memory, a NOR flash memory, an RRAM, a PRAM, an MRAM, a FRAM, a Spin Transfer Torque Random Access Memory (STT-RAM), and the like. The vertical NAND flash memory is disclosed in U.S. Patent Publication Nos. 2009/0306583, 2010/0078701, 2010/0117141, 2010/0140685, 2010/02135527, 2010/0224929, 2010/0315875, 2010/0322000, 2011/0013458, and 2011/0018036, the entirety of which is incorporated by reference herein.

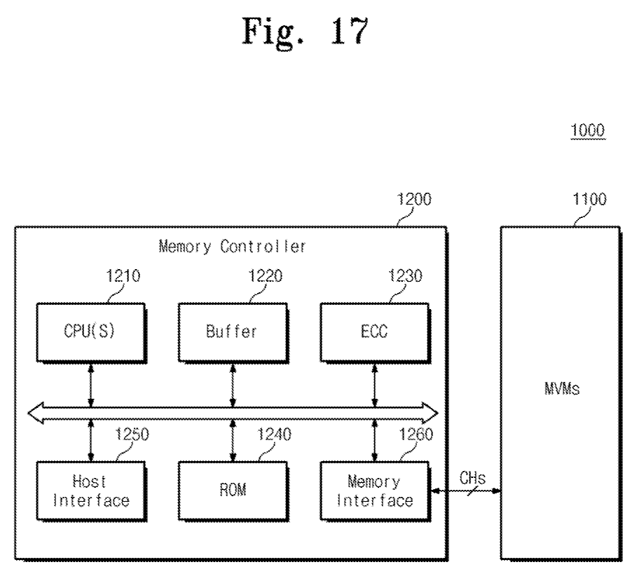

FIG. 17 is a block diagram illustrating a memory system according to an exemplary embodiment of the inventive concept. Referring to FIG. 17, a memory system 1000 may include a nonvolatile memory device 1200 and a memory controller 1200. The memory system 1000 may be configured to have the same function or operation as one of memory systems 200, 300, 400, 500, and 600 illustrated in FIGS. 4, 8, 10, 12, and 14.

The nonvolatile memory device 1100 may be configured to include the first and second memories in one of the memory systems 200, 300, 400, 500, and 600 illustrated in FIGS. 4, 8, 10, 12, and 14.

The memory controller 1200 may be connected to the nonvolatile memory device 1100 through a plurality of channels. The memory controller 1200 may include a controller in one of the memory systems 200, 300, 400, 500, and 600 illustrated in FIGS. 4, 8, 10, 12, and 14. The memory controller 1200 may include at least one Central Processing Unit (CPU) 1210, a buffer memory 1220, an Error Correction Circuit (ECC) 1230, a Read-Only Memory (ROM) 1240, a host interface 1250, and a memory interface 1260. The memory system 1000 may be applicable to PPN (Perfect Page New) device.

An exemplary memory system is disclosed in U.S Patent Publication No. 2010/0082890, the entirety of which is incorporated by reference herein.

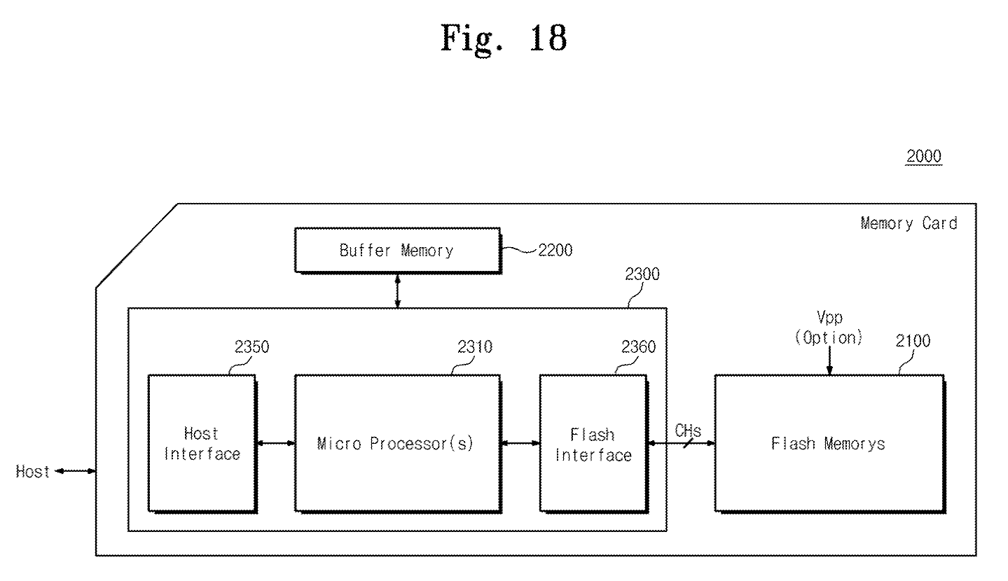

FIG. 18 is a block diagram of a memory card according to an exemplary embodiment of the inventive concept. Referring to FIG. 18, a memory card 2000 may include a flash memory device 2100, a buffer memory device 2200, and a memory controller 2300 for controlling the flash memory device 2100 and the buffer memory device 2200.

The memory card 2000 may be configured to have the same function or operation as one of memory systems 200, 300, 400, 500, and 600 illustrated in FIGS. 4, 8, 10, 12, and 14.

The flash memory device 2100 may include the first and second memories in one of the memory systems 200, 300, 400, 500, and 600 illustrated in FIGS. 4, 8, 10, 12, and 14.

The buffer memory device 2200 may be a device for temporarily storing data generated during an operation of the memory card 2000. The buffer memory device 2200 may be farmed of a DRAM or an SRAM.

The memory controller 2300 may be connected to the flash memory device 2100 through a plurality of channels. The memory controller 2300 may include a controller in one of the memory systems 200, 300, 400, 500, and 600 illustrated in FIGS. 4, 8, 10, 12, and 14. The memory controller 2300 may be connected between a host and the flash memory device 2100. The memory controller 2300 may access the flash memory device 2100 in response to a request from the host.

The memory controller 2300 may include at least one microprocessor 2310, a host interface 2350, and a flash interface 2360. The microprocessor 2310 may be configured to drive firmware. The host interface 235 may interface with the host through a card protocol (e.g., SD/MMC) for data exchanges between the host and the memory card 2000.

The memory card 2000 may be applicable to Multimedia Card (MMCs), Security Digital (SD) card, miniSD card, memory stick, smartmedia card, and transflash card.

An exemplary memory card is disclosed in U.S. Patent Publication No. 2010/0306583, the entirety of which is incorporated by reference herein.

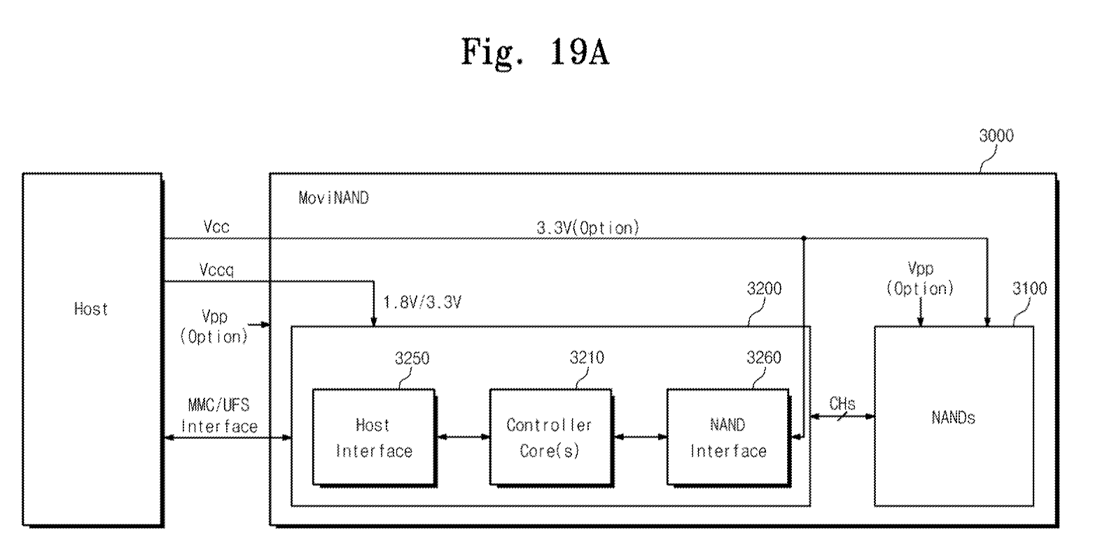

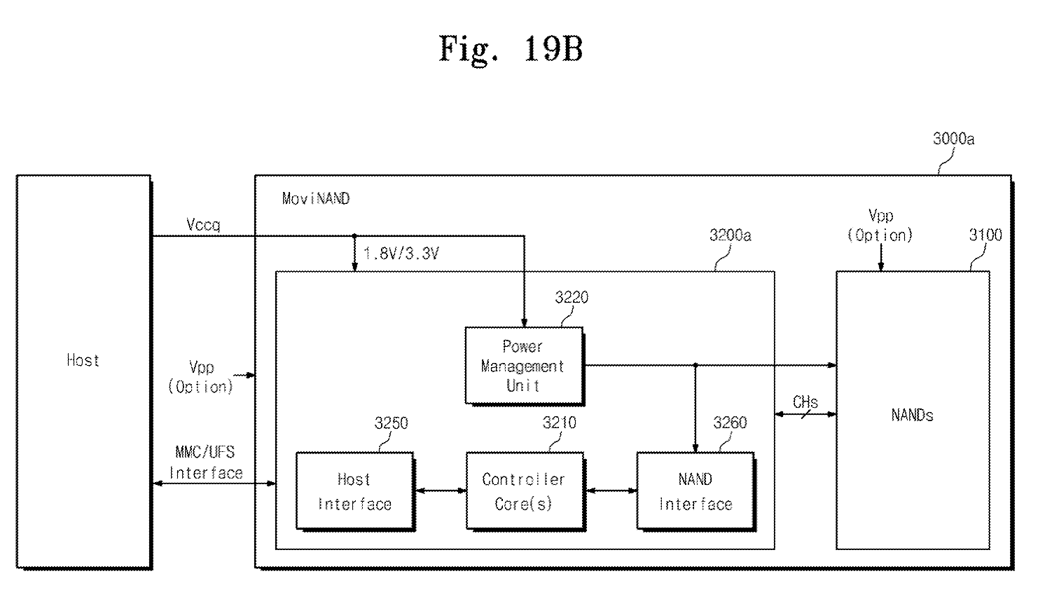

FIG. 19A is a block diagram illustrating a moviNAND device according to an exemplary embodiment of the inventive concept. Referring to FIG. 19A, a moviNAND device 3000 may include a NAND flash memory device 3100 and a controller 3200. The moviNAND device 3000 may support the MMC 4.4 (called eMMC) standard. The moviNAND device 3000 may be configured to have the same function or operation as one of memory systems 200, 300, 400, 500, and 600 illustrated in FIGS. 4, 8, 10, 12, and 14

The NAND flash memory device 3100 may include the first and second memories in one of the memory systems 200, 300, 400, 500, and 600 illustrated in FIGS. 4, 8, 10, 12, and 14. The NAND flash memory device 3100 may an SDR (single data rate) or DDR (double data rate) NAND flash memory device. The NAND flash memory device 3100 may include unitary NAND flash memories, which are stacked in one package (e.g., Fine-pitch Ball Grid Array (FBGA)).

The memory controller 3200 may be connected to the NAND flash memory device 3100 through a plurality of channels. The memory controller 3200 may include a controller of one of the memory systems 200, 300, 400, 500, and 600 illustrated in FIGS. 4, 8, 10, 12, and 14. The memory controller 3200 may include at least one controller core 3210, a host interface 3250, and a NAND interface 3260. The NAND interface 3260 may include an ECC circuit (not shown). The controller core 3210 may control an overall operation of the moviNAND device 3000.

The host interface 3250 may be configured to interface between the controller 3200 and a host. The NAND interface 3260 may be configured to interface between the NAND flash memory device 3100 and the memory controller 3200. In an exemplary embodiment, the host interface 3250 may be a parallel interface (e.g., an MMC interface). In another embodiment, the host interface 3250 of the moviNAND device 3000 may be a serial interface (e.g., UHS-II, UFS interface, etc.).

The moviNAND device 3000 may receive the first and second power supply voltages Vcc and Vccq from the host. Herein, the first power supply voltage Vcc (about 3.3V, optional application) may be supplied to the NAND flash memory device 3100 and the NAND interface 3260, while the second power supply voltage Vccq (about 1.8V/3.3V) may be supplied to the controller 3200.

In an exemplary embodiment, the moviNAND device 3000 may receive the external high voltage Vpp optionally.

In an exemplary embodiment, the NAND flash memory device 3100 may receive the external high voltage Vpp optionally.

As described in FIG. 19A, the moviNAND device 3000 receives least two power supplies Vcc and Vccq (exempt from the external high voltage Vpp (Option)) from the host. However, the inventive concept is not limited thereto. The moviNAND device 3000 may receive one power supply Vccq form the host.

FIG. 19B is a block diagram illustrating a moviNAND device according to another exemplary embodiment of the inventive concept. Referring to FIG. 19B, a moviNAND device 3000a may include a NAND flash memory device 3100 and a controller 3200a.

The memory controller 3200a may be connected to the NAND flash memory device 3100 through a plurality of channels. The memory controller 3200a may include a controller of one of the memory systems 200, 300, 400, 500, and 600 illustrated in FIGS. 4, 8, 10, 12, and 14. The memory controller 3200a may include at least one controller core 3210, at least one power management unit 3220, a host interface 3250, and a NAND interface 3260. The power management unit 3220 may receive the power supply voltage Vccq (1.8V/3.3V) and output the inner power supply voltage (e.g. 3.3V) to NAND interface 3260 and the NAND device 3100 by boosting or regulating the received power supply voltage Vccq.

An exemplary power management is detail disclosed in U.S. Pat. No. 7,092,308, the entirety of which is incorporated by reference herein.

The moviNAND devices 3000 and 3000a may be advantageous to store mass data and may have an improved read operation characteristic. The moviNAND devices 3000 and 3000a may be applicable to a mobile product (e.g., Galaxy S, iPhone, etc.).

The inventive concept may be applicable to a solid state drive (SSD).

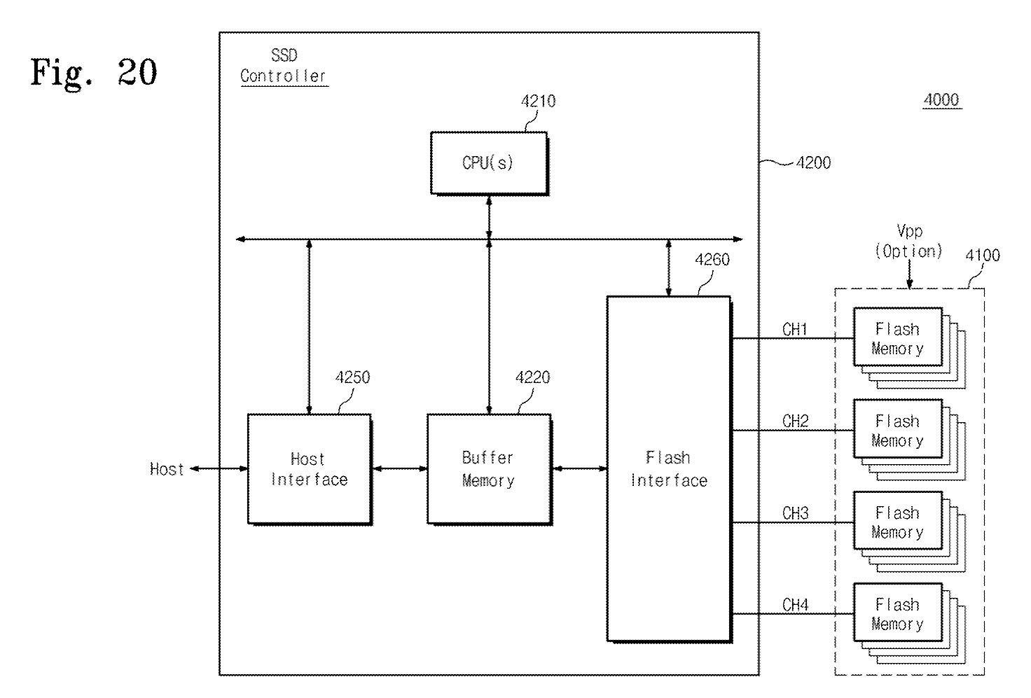

FIG. 20 is a block diagram illustrating an SSD according to an exemplary embodiment of the inventive concept. Referring to FIG. 20, an SSD 4000 may include a plurality of flash memory devices 4100 and an SSD controller 4200. The SSD 4000 may be configured to have the same function or operation as one of memory systems 200, 300, 400, 500, and 600 illustrated in FIGS. 4, 8, 10, 12, and 14.

The flash memory devices 4100 may include the first and second memories in one of the memory systems 200, 300, 400, 500, and 600 illustrated in FIGS. 4, 8, 10, 12, and 14.

The SSD controller 4200 may be connected to the flash memory devices 4100 through a plurality of channels CH1 to CH4. The SSD controller 4200 may include a controller in one of the memory systems 200, 300, 400, 500, and 600 illustrated in FIGS. 4, 8, 10, 12, and 14. The SSD controller 4200 may include a CPU 4210, a host interface 4250, a buffer memory 4220, and a flash interface 4260.

The buffer memory 4220 may be used to temporarily store data transferred between an external device and the flash memory devices 4100. The buffer memory 4220 may be used to store programs to be performed by the CPU 4210. The buffer memory 4220 may be formed of DRAM or SRAM. In FIG. 20, the buffer memory 4220 may be implemented to be included in the SSD controller 4200. However, the inventive concept is not limited thereto. For example, the buffer memory 4220 may be disposed outside the SSD controller 4200.

Under the control of the CPU 4210, the host interface 4250 may exchange data with a host through through the communication protocol, for example, the ATA protocol. The ATA protocol may include a Serial Advanced Technology Attachment (SATA) interface, a Parallel Advanced Technology Attachment (PATA) interface, and an External SATA (ESATA) interface. In another exemplary the communication protocol may include a Universal Serial Bus (USB) interface.

Data to be received or transmitted from or to the host through the host interface 4250 is delivered to the buffer memory 4220 without passing through a CPU bus, under the control of the CPU 4210.

The flash interface 4260 may be configured to interface between the SSD controller 4200 and the flash memory devices 4100 that are used as storage devices. The flash interface 4260 may be configured to support at least one of NAND flash memories, One-NAND flash memories, multi-level flash memories, or single-level flash memories.

The SSD 4000 may improve the reliability of data by storing random data at a program operation. An exemplary SSD is disclosed in U.S. Patent Publication No. 2010/0082890, the entirety of which is incorporated by reference herein.

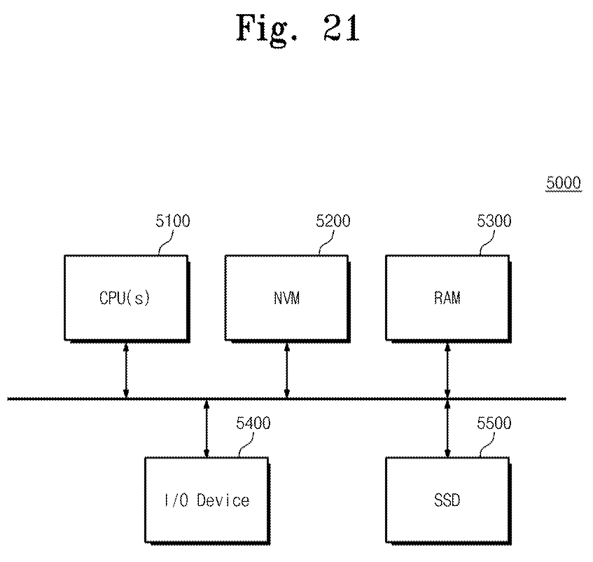

FIG. 21 is a block diagram illustrating a computing system according to an exemplary embodiment of the inventive concept. Referring to FIG. 21, a computing system 5000 may include at least one CPU 5100, a nonvolatile memory device 5200, a RAM 5300, an input/output (I/O) device 5400, and an SSD 5500.

The CPU 5100 may be connected to a system bus. The nonvolatile memory device 5200 may store data used to drive the computing system 5000. Herein, the data may include a start command sequence or a basic I/O system (BIOS) sequence. The RAM 5300 may temporarily store data generated during the execution of the CPU 5100.

The I/O device 5400 may be connected to the system bus through an I/O device interface. The I/O device 5400 may include keyboards, pointing devices (e.g., mouse), monitors, and modems.

The SSD 5500 may be a readable storage device and may be implemented the same as an SSD 4000 in FIG. 20.

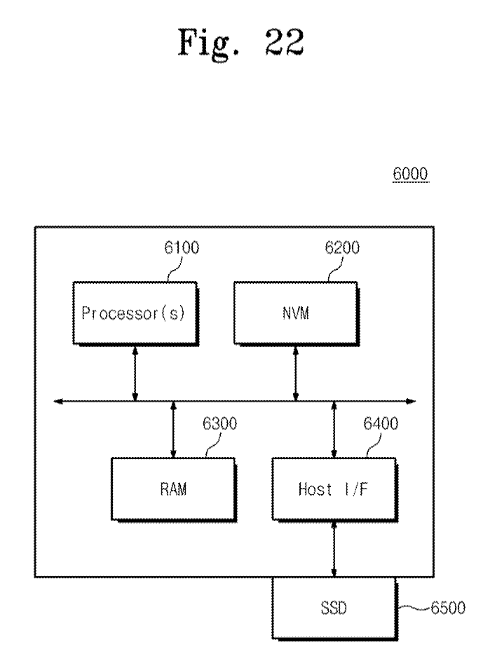

FIG. 22 is a block diagram illustrating an electronic device according to an exemplary embodiment of the inventive concept. Referring to FIG. 22, an electronic device 6000 may include a processor 6100, a ROM 6200, a RAM 6300, a flash interface (I/F) 6400, and an SSD 6500.

The processor 6100 may access the RAM 6300 to execute firmware codes or other necessary codes. The processor 6100 may access the ROM 6200 to execute various command sequences such as a start command sequence and a basic I/O system (BIOS) sequence. The flash interface 6400 may be configured to interface between the electronic device 6000 and the SSD 6500.

The SSD 6500 may be detachable from the electronic device 6000. The SSD 6500 may be implemented the same as an SSD 4000 in FIG. 20.

Examples of the electronic device 6000 may include cellular phones, personal digital assistants (PDAs), digital cameras, camcorders, portable audio players (e.g., MP3), and portable media players (PMPs).

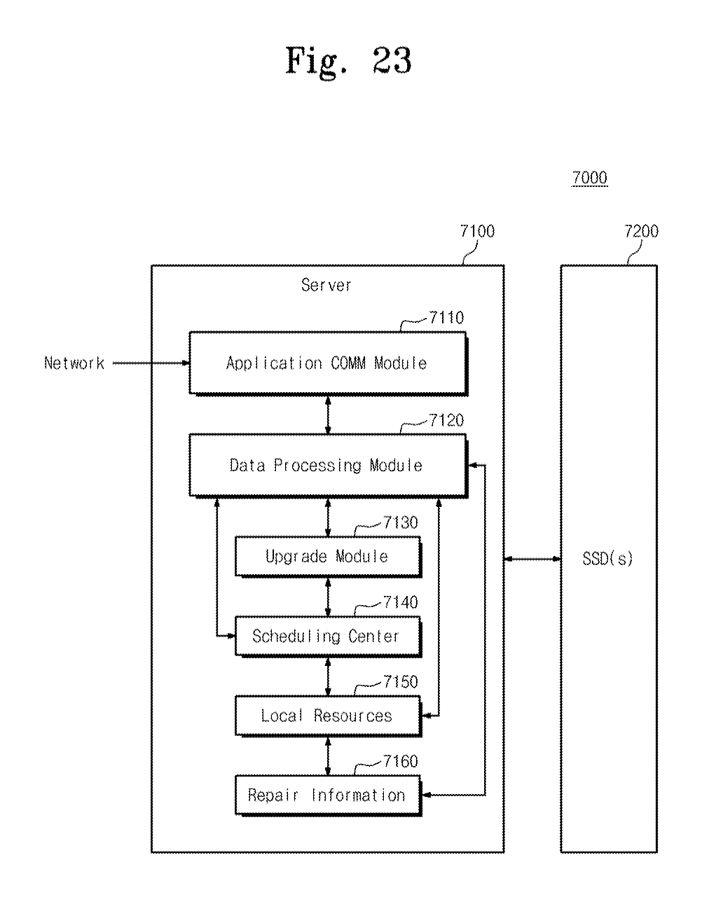

FIG. 23 is a block diagram illustrating a server system including an SSD in FIG. 20 according to an exemplary embodiment of the inventive concept. Referring to FIG. 23, a server system 7000 may include a server 7100 and at least one SSD 7200 that stores data used to drive the server 7100. The SSD 7200 may be configured the same as an SSD 4000 in FIG. 20.

The server 7100 may include an application communication module 7110, a data processing module 7120, an upgrade module 7130, a scheduling center 7140, a local resource module 7150, and a repair information module 7160.

The application communication module 7110 may be configured to communicate with a computing system connected to a network and the server 7100, or to allow the server 7100 to communicate with the SSD 7200. The application communication module 7110 may transmit data or information, provided through a user interface, to the data processing module 7120.

The data processing module 7120 may be linked to the local resource module 7150. Herein, the local resource module 7150 may provide a list of repair shops/dealers/technical information to a user on the basis of information or data inputted to the server 7100.

The upgrade module 7130 may interface with the data processing module 7120. Based on information or data received from the SSD 7200, the upgrade module 7130 may perform upgrades of a firmware, a reset code, a diagnosis system, or other information on electronic appliances.

The scheduling center 7140 may provide real-time options to the user based on the information or data inputted to the server 7100.

The repair information module 7160 may interface with the data processing module 7120. The repair information module 7160 may be used to provide repair-related information (e.g., audio, video or document files) to the user. The data processing module 7120 may package information related to the information received from the SSD 7200. The packaged information may be transmitted to the SSD 7200 or may be displayed to the user.

A memory system according to an exemplary embodiment of the inventive concept may be applicable to a PPN (Perfect Page New) device.

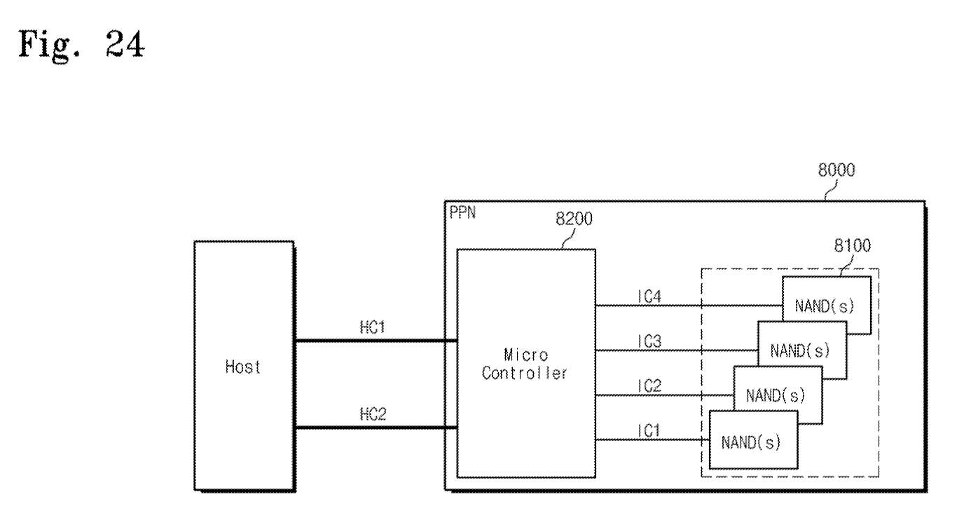

FIG. 24 is a block diagram illustrating a PPN device according to an exemplary embodiment of the inventive concept. Referring to FIG. 24, a PPN device 8000 may include a plurality of NAND flash memories 8100 and a controller 8200 for controlling the plurality of NAND flash memories 8100. The PPN device 8000 may be configured to have the same function or operation as one of memory systems 200, 300, 400, 500, and 600 in FIGS. 4, 8, 10, 12, and 14.

The PPN device 8000 may communicate with a host through the PPN protocol having a DDR (double data rate) interface. Data communication between the PPN device 8000 and the host may be made through the first and second host channels HC1 and HC2. Herein, the number of host channels is not limited to 2. The PPN device 8000 may guarantee the reliability of data such that the host does not include an ECC engine. For example, the PPN device 8000 may guarantee 3000 program/erase cycles over three years.

The NAND flash memories 8100 may include the first and second memories in one of memory systems 200, 300, 400, 500, and 600 in FIGS. 4, 8, 10, 12, and 14.

The controller 8200 may be connected to the NAND flash memories 8100 through a plurality of channels IC1 to IC4. The controller may include a controller of one of the memory systems 200, 300, 400, 500, and 600 in FIGS. 4, 8, 10, 12, and 14.

Data communication between the NAND flash memories 8100 and the controller 8200 may be made through the inner channels IC1 to IC4. Herein, the number of inner channels is not limited to 4.

A memory system according to an exemplary embodiment of the inventive concept may be applicable to a tablet product (e.g., Galaxy S, iPad, etc.).

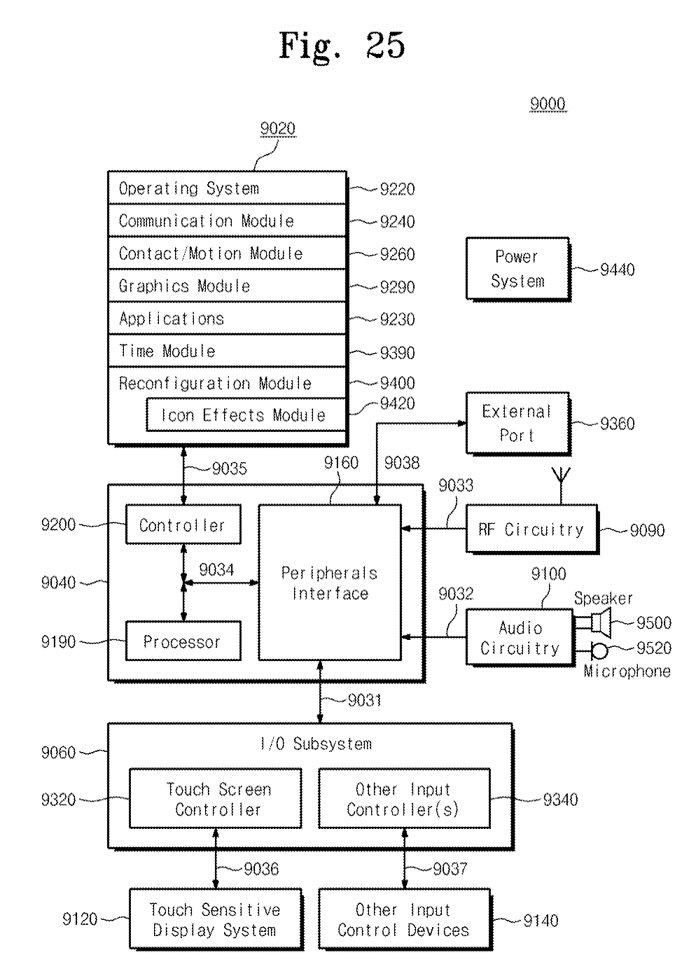

FIG. 25 is a block diagram illustrating a mobile electronic device according to an exemplary embodiment of the inventive concept. Referring to FIG. 25, a mobile electronic device 9000 may include at least one computer-readable medium 9020, a processing system 9040, an input/output sub-system 9060, a radio frequency circuit 9080, and an audio circuit 9100. The elements may be interconnected through at least one communication bus or signal lines 9031 to 9038.

The mobile electronic device 9000 may be a device including an unlimited handheld computer, a tablet computer, a cellular phone, a media player, a PDA, and a combination of at least two thereof Herein, the computer-readable medium 9020 may be configured to include one of memory systems 200, 300, 400, 500, and 600 in FIGS. 4, 8, 10, 12, and 14. An exemplary mobile electronic device is disclosed in U.S. Pat. No. 7,509,588, the entirety of which is incorporated by reference herein.

The memory systems or the storage devices according to the inventive concept may be mounted in various types of packages. Examples of the packages of the memory system or the storage device according to the inventive concept may include Package on Package (PoP), Ball Grid Arrays (BGAs), Chip Scale Packages (CSPs), Plastic Leaded Chip Carrier (PLCC), Plastic Dual In-line Package (PDIP), Die in Waffle Pack, Die in Wafer Form, Chip On Board (COB), Ceramic Dual In-line Package (CERDIP), Plastic Metric Quad Flat Pack (MQFP), Thin Quad Flat Pack (TQFP), Small Outline Integrated Circuit (SOIC), Shrink Small Outline Package (SSOP), Thin Small Outline Package (TSOP), System In Package (SIP), Multi Chip Package (MCP), Wafer-level Fabricated Package (WFP), and Wafer-level Processed Stack Package (WSP).

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. A data transfer method of a memory system, comprising:
reading data from a first non-volatile memory having at least one first chip connected to a controller through a first channel; and
transferring the read data to a second non-volatile memory having at least one second chip connected to the controller through a second channel,
wherein each of the first and second channels include at least one line for activating a corresponding chip,
wherein the first and second channels share at least one data line, and
wherein data transfer operations in the first and second channels are performed in response to data strobe signals.

2. The data transfer method of claim 1, wherein the reading data from a first non-volatile memory comprises:
reading data in response to a read enable signal; and
outputting the read data to the first channel in response to a first data strobe signal of the data strobe signals.

3. The data transfer method of claim 2, wherein the outputting the read data to the first channel comprises outputting the read data in response to toggling of the first data strobe signal.

4. The data transfer method of claim 2, wherein the transferring the read data to the second non-volatile memory comprises receiving the read data in response to a second data strobe signal of the data strobe signals by the second memory.

5. The data transfe+r method of claim 4, wherein the controller is configured to generate the first and second data strobe signals.

6. The data transfer method of claim 5, wherein the first and second data strobe signals are single-ended signals.

7. The data transfer method of claim 5, wherein the first and second data strobe signals are differential signals.

8. The data transfer method of claim 4, wherein the controller is configured to generate the second data strobe signal by delaying the first data strobe signal by a predetermined time.

9. The data transfer method of claim 8, wherein the controller is configured to generate the second data strobe signal such that an edge of the second data strobe signal is located at a center of the output data.

10. The data transfer method of claim 1, further comprising:
correcting an error of the read data.

11. The data transfer method of claim 10, wherein the read data is output to the first channel in response to a first data strobe signal of the data strobe signals, the error-corrected data is provided to the second channel in response to a second data strobe signal of the data strobe signals, and wherein the second data strobe signal is generated by delaying the first data strobe signal by a time taken to correct an error of the read data.

12. The data transfer method of claim 11, wherein the first non-volatile memory is configured to correct an error of the read data.

13. The data transfer method of claim 11, wherein the controller is configured to correct an error of the read data.

14. The data transfer method of claim 1, wherein the reading data from the first non-volatile memory comprises:
reading data in synchronization with a clock; and
outputting the read data to the first channel in response to a first data strobe signal of the data strobe signals.

15. A memory system comprising:
a first non-volatile memory having at least one first chip;
a second non-volatile memory having at least one second chip; and
a controller configured to connect to the first non-volatile memory through a first channel and the second non-volatile memory through a second channel and to control the first and second non-volatile memories,
wherein the respective first and second channels include at least one line for activating the first and second chips respectively,
wherein the first and second channels share at least one data line, and
wherein data transfer operations in the first and second channels are performed in response to data strobe signals.

16. The memory system of claim 15, wherein the controller includes an ECC circuit configured to correct an error of data.

17. The memory system of claim 16, wherein when data is transferred from the first non-volatile memory to the second non-volatile memory, the controller is configured to receive data read from the first non-volatile memory through the first channel, correct an error of the input data in real time, and transfer the error-corrected data to the second non-volatile memory through the second channel.

18. The memory system of claim 17, wherein the read data is transferred to the controller through the first channel in response to a first data strobe signal of the data strobe signals and the error-corrected data is transferred through the second channel in response to a second data strobe signal of the data strobe signals.

19. The memory system of claim 18, wherein the controller includes a data strobe signal generator configured to generate the first and second data strobe signals.

20. The memory system of claim 15, wherein the at least one line includes at least one line receiving at least one chip enable signal, at least one line receiving at least one data strobe signal, a line receiving a write protection signal, and at least one line outputting at least one ready/busy signal.

21. The memory system of claim 20, wherein the first and second channels share a line receiving an address latch signal and a line receiving a command latch signal.

22. A memory system comprising:
a first non-volatile memory having at least one first chip;
a second non-volatile memory having at least one second chip; and
a controller configured to connect to the first non-volatile memory through a first channel and the second non-volatile memory through a second channel and to control the first and second non-volatile memories,
wherein the respective first and second channels include at least one line for activating the first and second chips respectively,
wherein the first channel includes at least one first data line for outputting the read data,
wherein the second channel includes at least one second data line for inputting the output data,
wherein the first and second data lines are separated, and
wherein data transfer operations in the first and second channels are performed in response to data strobe signals.

23. The memory system of claim 22, wherein the first and second non-volatile memories are configured to receive a shared clock.
